(19) United States
(12) Patent Application Publication
(10) Pub. No.: US 2020/0282995 A1
(43) Pub. Date: Sep. 10, 2020

(54) VEHICLE SYSTEM AND METHOD FOR CONTROLLING DRIVING THEREOF

(71) Applicants: HYUNDAI MOTOR COMPANY, Seoul (KR); KIA MOTORS CORPORATION, Seoul (KR)

(72) Inventors: Byeong Wook JEON, Seoul (KR); Kwang Hee PARK, Suwon-si (KR); Jae Chang KOOK, Hwaseong-si (KR); Sang Jun PARK, Seoul (KR)

(21) Appl. No.: 16/545,466

(22) Filed: Aug. 20, 2019

(30) Foreign Application Priority Data
Mar. 5, 2019 (KR) 10-2019-0025351

(51) Int. Cl. B60W 30/18; B60W 30/14; B60W 10/02; B60W 10/06; G05D 1/02

(52) U.S. Cl. CPC B60W 30/18072; B60W 30/143; B60W 10/02; B60W 2720/10; G05D 1/0223; B60W 2710/021; B60W 2710/0666; B60W 10/06

(57) ABSTRACT

A vehicle system includes: a driving control device that controls driving of a vehicle based on a target speed; a transmission control device that transmits a speed control prohibition request to the driving control device when an acceleration event occurs while the vehicle is in a neutral state, and engages a clutch of a transmission while the speed control is prohibited by the driving control device; and an engine control device that outputs a predetermined engine torque in response to a reception of an engine torque control signal from the driving control device.

### CROSS-REFERENCE TO RELATED APPLICATION

This application claims the benefit of priority to Korean Patent Application No. 10-2019-0025351, filed in the Korean Intellectual Property Office on Mar. 5, 2019, the entire contents of which are incorporated herein by reference.

### TECHNICAL FIELD

The present disclosure relates to a vehicle system and a method for controlling driving thereof.

### BACKGROUND

When a coasting neutral control is applied to a vehicle equipped with an automatic travel function, such as an auto cruise control while the vehicle is in an auto cruise control state, a transmission automatically enters a neutral state during coasting driving. In this case, as the transmission enters the neutral state, a clutch is engaged each time when there is a torque increase request for maintaining a speed from the cruise control, thereby causing an impact.

When a driver directly drives the vehicle, the driver recognizes that the transmission is in the neutral state through a cluster display of a dash board or the like while coasting neutral control is performed. Therefore, the impact that occurs when the clutch is engaged by an acceleration operation may be predicted in some degree.

However, when the driver does not intervene in driving operations as in a case of the auto cruise control or the autonomous driving, the impact that occurs when the clutch is engaged to control acceleration during the coasting neutral control may not be predicted, therefore, the driver may feel a sense of heterogeneity due to the impact.

Especially, when the auto cruise control function is performed, acceleration and deceleration operations may be frequently performed to maintain the speed, so that neutral state and engaged state of the clutch may be frequently repeated. Therefore, complaints due to the impact of shift may be increased.

### SUMMARY

The present disclosure has been made to solve the above-mentioned problems occurring in the prior art while advantages achieved by the prior art are maintained intact.

An aspect of the present disclosure provides a vehicle system and a method for controlling driving thereof that performs shift control while keeping an engine torque at zero through cooperative control between a driving control device, a transmission control device, and an engine control device before acceleration to engage a clutch rapidly without a sense of heterogeneity due to shift impact to accelerate a vehicle smoothly, when an acceleration event occurs by speed control of cruise control during coasting neutral control while auto cruise control is performed.

The technical problems to be solved by the present inventive concept are not limited to the aforementioned problems, and any other technical problems not mentioned herein will be clearly understood from the following description by those skilled in the art to which the present disclosure pertains.

According to an exemplary embodiment of the present disclosure, a vehicle system includes: a driving control device that controls driving of a vehicle based on a target speed; a transmission control device that transmits a speed control prohibition request to the driving control device when an acceleration event occurs while the vehicle is in a neutral state, and engages a clutch of a transmission while a speed control is prohibited by the driving control device; and an engine control device that outputs a predetermined engine torque in response to a reception of an engine torque control signal from the driving control device.

The driving control device may prevent the engine torque control signal from being output based on a reception of the speed control prohibition request from the transmission control device.

The transmission control device may request a deactivation of the speed control prohibition to the driving control device, when the clutch of the transmission is engaged.

The driving control device may transmit the engine torque control signal to an engine control device in response to a reception of the deactivation of the speed control prohibition request from the transmission control device.

The engine torque control signal may request an increase in an engine torque.

The transmission control device may perform neutral control on the clutch of the transmission in coasting driving while a vehicle speed is equal to or above a lower limit value of the target speed.

The acceleration event may occur when a vehicle speed during coasting driving is below a lower limit value of the target speed.

The driving control device may control the driving of the vehicle based on an auto cruise control function.

The driving control device may control the driving of the vehicle based on an autonomous drive function.

According to another exemplary embodiment of the present disclosure, a method for controlling driving of a vehicle system includes: controlling, by a driving control device, driving of a vehicle based on a target speed; transmitting, by a transmission control device, a speed control prohibition request to the driving control device when an acceleration event occurs while the vehicle is in a neutral state; engaging, by the transmission control device, a clutch of a transmission while a speed control is prohibited by the driving control device; and outputting, by an engine control device, a predetermined engine torque in response to a reception of an engine torque control signal of the driving control device when the clutch of the transmission is engaged.

The method according to an embodiment of the present disclosure may further include preventing, by the driving control device, the engine torque control signal from being output based on a reception of the speed control prohibition request from the transmission control device.

The method according to an embodiment of the present disclosure may further include requesting, by the transmission control device, a deactivation of the speed control prohibition to the driving control device, when the clutch of the transmission is engaged, and transmitting, by the driving control device, the engine torque control signal to the engine control device in response to a reception of the deactivation of the speed control prohibition request from the transmission control device.

The engine torque control signal may request an increase in an engine torque.

The method according to an embodiment of the present disclosure may further include performing neutral control, by the transmission control device, on the clutch of the transmission in coasting driving while a vehicle speed is equal to or above a lower limit value of the target speed.

The acceleration event may occur when a vehicle speed during coasting driving is below a lower limit value of the target speed.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a vehicle system to which a device according to an exemplary embodiment of the present disclosure is applied.

FIG. 2 illustrates an embodiment of signals referenced to illustrate operations of a vehicle system according to an exemplary embodiment of the present disclosure.

FIG. 3 is a flow chart of a method for controlling driving of a vehicle system according to an exemplary embodiment of the present disclosure.

FIG. 4 illustrates a computing system in which a method according to an exemplary embodiment of the present disclosure is implemented.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

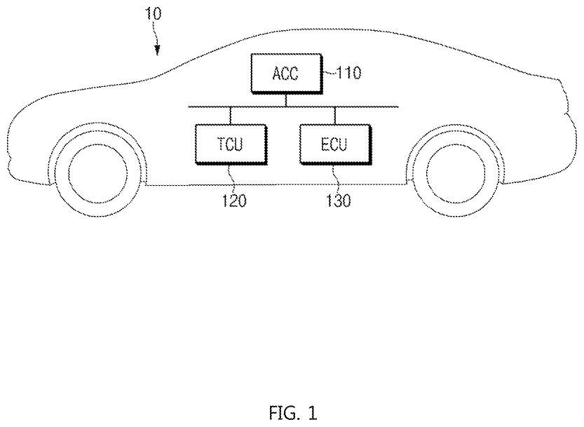

FIG. 1 illustrates a vehicle system according to an exemplary embodiment of the present disclosure.

Referring to FIG. 1, the vehicle system according to the present disclosure may include a driving control device 110, a transmission control device 120, and an engine control device 130.

The driving control device 110 may be implemented as an auto cruise control (ACC) system, an autonomous travel system, or the like within a vehicle. The transmission control device 120 may be implemented in a form of a transmission control unit (TCU) within a vehicle. The engine control device 130 may be implemented in a form of an engine control unit (ECU) within a vehicle.

In this connection, the auto cruise control system refers to an electronic automatic speed control system that, when a target speed is set, automatically controls a brake and an accelerator to travel at the set target speed.

The driving control device 110 automatically controls acceleration and deceleration to allow the vehicle to travel at the target speed while maintaining a set vehicle-to-vehicle distance constant. In this connection, the driving control device 110 separates an engine and a transmission from a clutch during coasting driving to increase a coasting distance, thereby increasing a fuel efficiency.

In order to obtain driving force even though a driver does not operate the accelerator pedal, the brake pedal, or the like, the driving control device 110 may transmit a virtual control signal to the transmission control device 120 and/or the engine control device to request to shift a transmission lever and/or to vary an engine torque.

The driving control device 110 controls the driving based on the target speed when an autonomous driving function is executed. The driving control device 110 may request the transmission control device 120 to perform neutral control and may perform the coasting driving when the autonomous driving function is executed.

In this connection, the coasting driving means that the vehicle travels only by inertia force without further acceleration considering a distance from a preceding vehicle, a signal, or the like. When excessive acceleration and deceleration are repeated, fuel consumption is increased and the fuel efficiency is lowered. However, the coasting driving may allow stable driving without unnecessary acceleration, thereby increasing the fuel efficiency.

Further, when a vehicle speed is below a lower limit value of the set target speed during the coasting driving, the driving control device 110 may request the transmission control device 120 to deactivate the neutral control for acceleration control.

Further, when the transmission control device 120 completes the neutral control deactivation, the driving control device 110 may transmit a torque control signal to the engine control device 130 to request the acceleration control.

The transmission control device 120 monitors a driving state of the vehicle while the vehicle is driving, and electrically controls solenoid valves based on the driving state of the vehicle. In this connection, the solenoid valves controlled by the transmission control device 120 actuate hydraulic pressure valves, and thus, the hydraulic pressure valves control hydraulic pressures acting on corresponding transmission elements, thereby driving or braking the plurality of transmission elements, thus to shift a gear. A shift pattern of the transmission control device 120 may vary depending on the driving state of the vehicle.

During the coasting driving, the transmission control device 120 disengages the clutch and controls a gear stage to be in a neutral position.

Further, when the neutral control deactivation request signal is received from the driving control device 110 in the event of the acceleration, the transmission control device 120 deactivates the neutral control and shifts the gear stage from an N-gear to a D-gear.

In this connection, the transmission control device 120 transmits a speed control prohibition request signal to the driving control device 110 before deactivating the neutral control.

At this time, when the speed control prohibition request signal is received from the transmission control device 120, the driving control device 110 waits without transmitting the torque control signal to the engine control device 130 until the shift is completed. Accordingly, the transmission control device 120 engages the clutch to the gear stage D and deactivates the neutral control while the speed control is being prohibited.

When the clutch engagement is completed, the transmission control device 120 transmits a speed control permission signal to the driving control device 110.

When the speed control permission signal is received from the transmission control device 120, the driving control device 110 transmits the torque control signal to the engine control device 130.

The engine control device 130 controls internal operations of the engine such as a fuel injection quantity of the engine, ignition timing, engine RPM, variable valve timing, and a booster level of a turbocharger, or the like.

The engine control device 130 may output the engine torque based on a reception of the control signal from the driving control device 110 to control the acceleration or deceleration of the vehicle.

The engine control device 130 does not receive the torque control signal from the driving control device 110 while the shift control is being performed by the transmission control device 120. Accordingly, the engine control device 130 outputs the engine torque at ‘0’. Thus, the transmission control device 120 may engage the clutch of transmission to the D-gear in an engine off (torque=0) state.

In this case, engine overrun at the beginning of the shift and fluid coupling at the end of the shift may not occur in the vehicle.

Further, when the torque control signal is received from the driving control device 110 after the clutch of the transmission is engaged to the D-gear, the engine control device 130 outputs an engine torque corresponding to the torque control signal.

Therefore, the acceleration performance may be improved as the vehicle is accelerated after the transmission is engaged to the D-gear.

Each of the devices according to the present disclosure may be implemented within the vehicle. In this connection, the devices may be integrally formed with internal controllers of the vehicle, or may be implemented as separate devices and connected to the controllers of the vehicle via separate connecting means.

Each of the devices according to the present embodiment operating as described above may be implemented in a form of an independent hardware device including a memory and a processor that processes each operation and may be implemented in a form that is included in another hardware device such as a microprocessor or a general purpose computer system.

In this connection, the memory may include a storage medium such as a Random Access Memory (RAM), a Static Random Access Memory (SRAM), a Read-Only Memory (ROM), a Programmable Read-Only Memory (PROM), and an Electrically Erasable Programmable Read-Only Memory (EEPROM).

The memory of each device may store data and/or algorithms necessary for the corresponding device to operate.

In addition, the driving control device 110, the transmission control device 120, and the engine control device 130 of the vehicle system may include a communicator supporting vehicle network communication. Each device may transmit and receive signals to and from each other via the communicator.

In this connection, the vehicle network communication technology may include a Controller Area Network (CAN) communication, a Local Interconnect Network (LIN) communication, and/or a Flex-Ray communication, and the like. In addition, any technology that supports in-vehicle communication may be applied thereto.

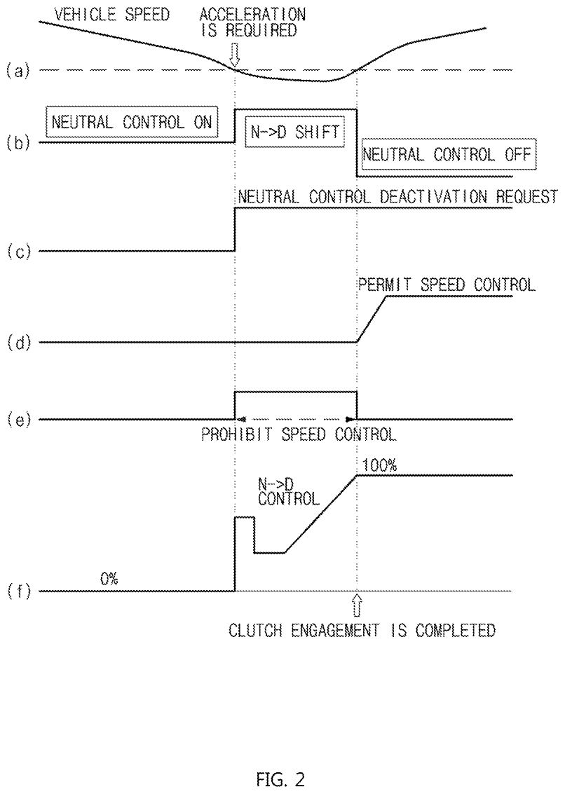

FIG. 2 illustrates signals for controlling operations of a vehicle system according to an embodiment of the present disclosure. Referring to FIG. 2, (a) shows a vehicle speed signal of the vehicle, (b) shows a neutral control signal, (c) shows a neutral control deactivation request signal, (d) shows an engine torque control signal, (e) shows a speed control prohibition request signal, and (f) shows a change in a shifting hydraulic pressure signal.

First, when the vehicle speed is equal to or above the lower limit value of the target speed as shown in (a), the transmission control device 120 maintains the neutral control (NCC) state during the coasting driving as shown in (b).

Further, when the vehicle speed signal of (a) becomes below the lower limit value of the target speed, an acceleration event occurs.

When the acceleration event occurs, the driving control device 110 transmits the neutral control deactivation request signal to the transmission control device 120 as shown in (c).

Then, the transmission control device 120 deactivates the neutral control as shown in (b) and performs an N->D shift control.

However, the transmission control device 120 transmits the speed control prohibition request signal to the driving control device 110 as shown in (e), before performing the N->D shift control. In this case, the driving control device 110 does not transmit the engine torque control signal to the engine control device 130 while the N->D shift control is being performed.

Therefore, the engine torque is maintained at zero until the clutch is engaged as shown in (d).

The transmission control device 120 performs the N-D shift control as shown in (b) while the engine torque is 0 (zero), and the change in the shift hydraulic pressure may be represented as (f).

As shown in (f), the transmission control device 120 engages the clutch to the D-gear while the engine torque is 0 (zero), therefore, the engine overrun at the beginning of the shift or the fluid coupling at the end of the shift does not occur.

The transmission control device 120 deactivates the neutral control when the N->D shift control is completed as shown in (b), and stops the transmission of the speed control prohibition request signal as shown in (e).

In this case, the driving control device 110 transmits the engine torque control signal to the engine control device 130 because the clutch engagement is completed. Therefore, the engine torque is increased to a predetermined level after the clutch is engaged as shown in (d), so that the engine is driven to accelerate the vehicle.

An operation flow of the vehicle system according to the present disclosure configured as described above will be described in more detail as follows.

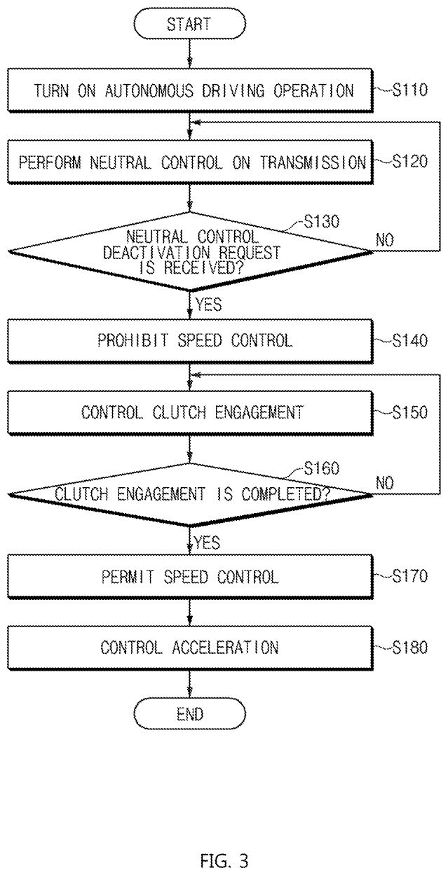

FIG. 3 is a flow chart of a method for controlling driving of a vehicle system according to an exemplary embodiment of the present disclosure.

Referring to FIG. 3, when the coasting driving due to downhill driving or the like while the auto cruise function of the vehicle is turned on, the transmission control device 120 performs the neutral control on the transmission (S110 and S120).

Thereafter, when the acceleration event occurs as the vehicle speed becomes below the target speed lower limit value, the driving control device 110 requests the transmission control device 120 to deactivate the neutral control. Therefore, when the neutral control deactivation request is received from the driving control device 110 (S130), the transmission control device 120 requests the speed control prohibition to the driving control device 110 before the neutral control is deactivated.

Accordingly, the driving control device 110 prohibits the speed control based on a reception of the request of the transmission control device 120 (S140). In this case, the driving control device 110 does not transmit the engine torque control signal to the engine control device 130.

The transmission control device 120 performs the shift control while the speed control is prohibited by the driving control device 110 to engage the clutch to a target gear stage. At this time, the transmission control device 120 may engage the clutch to the target gear stage while the engine torque is zero (S150).

When the clutch engagement is completed (S160), the transmission control device 120 requests the driving control device 110 to deactivate the speed control prohibition. Accordingly, the driving control device 110 permits the speed control based on a reception of the request from the transmission control device 120 (S170).

Thereafter, the driving control device 110 transmits the engine torque control signal requesting the increase in the engine torque such that the vehicle speed reaches the target speed to the engine control device 130 so as to accelerate the vehicle (S180). Accordingly, the engine control device 130 outputs an engine torque corresponding to the engine torque control signal from the driving control device 110, thereby increasing the vehicle speed.

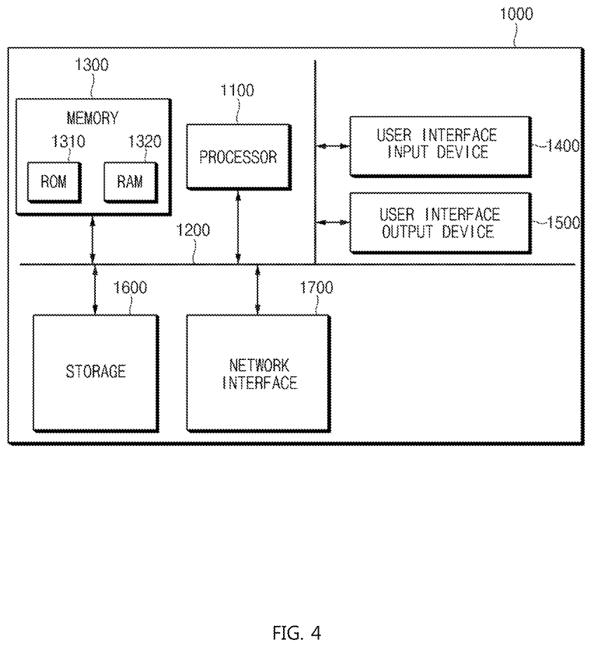

FIG. 4 illustrates a computing system in which a method according to an embodiment of the present disclosure is implemented.

Referring to FIG. 4, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM memory, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

According to the present disclosure, when the acceleration event occurs by the speed control of the cruise control during the coasting neutral control while the auto cruise control is performed, the shift control is performed while keeping an engine torque at zero through cooperative control between a driving control device, a transmission control device, and an engine control device before the acceleration such that the clutch is engaged rapidly without the sense of heterogeneity due to the shift impact, thereby accelerating the vehicle smoothly.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle system comprising:
a driving control device configured to control driving of a vehicle based on a target speed;
a transmission control device configured to:
transmit a speed control prohibition request to the driving control device when an acceleration event occurs while the vehicle is in a neutral state, and
engage a clutch of a transmission while a speed control is prohibited by the driving control device; and
an engine control device configured to output a predetermined engine torque in response to a reception of an engine torque control signal from the driving control device.

2. The vehicle system of claim 1, wherein the driving control device prevents the engine torque control signal from being output based on a reception of the speed control prohibition request from the transmission control device.

3. The vehicle system of claim 1, wherein the transmission control device requests a deactivation of the speed control prohibition to the driving control device, when the clutch of the transmission is engaged.

4. The vehicle system of claim 3, wherein the driving control device transmits the engine torque control signal to the engine control device in response to a reception of the deactivation of the speed control prohibition request from the transmission control device.

5. The vehicle system of claim 1, wherein the engine torque control signal requests an increase in an engine torque.

6. The vehicle system of claim 1, wherein the transmission control device performs neutral control on the clutch of the transmission in coasting driving while a vehicle speed is equal to or above a lower limit value of the target speed.

7. The vehicle system of claim 1, wherein the acceleration event occurs when a vehicle speed during coasting driving is below a lower limit value of the target speed.

8. The vehicle system of claim 1, wherein the driving control device controls the driving of the vehicle based on an auto cruise control function.

9. The vehicle system of claim 1, wherein the driving control device controls the driving of the vehicle based on an autonomous drive function.

10. A method for controlling driving of a vehicle system, the method comprising:
controlling, by a driving control device, driving of a vehicle based on a target speed;
transmitting, by a transmission control device, a speed control prohibition request to the driving control device when an acceleration event occurs while the vehicle is in a neutral state;
engaging, by the transmission control device, a clutch of a transmission while a speed control is prohibited by the driving control device; and
outputting, by an engine control device, a predetermined engine torque in response to a reception of an engine torque control signal of the driving control device when the clutch of the transmission is engaged.

11. The method of claim 10, further comprising:
preventing, by the driving control device, the engine torque control signal from being output based on a reception of the speed control prohibition request from the transmission control device.

12. The method of claim 10, further comprising:
requesting, by the transmission control device, a deactivation of the speed control prohibition to the driving control device, when the clutch of the transmission is engaged; and
transmitting, by the driving control device, the engine torque control signal to the engine control device in response to a reception of the deactivation of the speed control prohibition request from the transmission control device.

13. The method of claim 10, wherein the engine torque control signal requests an increase in an engine torque.

14. The method of claim 10, further comprising:
performing neutral control, by the transmission control device, on the clutch of the transmission in coasting driving while a vehicle speed is equal to or above a lower limit value of the target speed.

15. The method of claim 10, wherein the acceleration event occurs when a vehicle speed during coasting driving is below a lower limit value of the target speed.
